(19) United States
(12) Patent Application Publication
(10) Pub. No.: US 2026/0073415 A1
(43) Pub. Date: Mar. 12, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Ryusei ASADA, Tokyo (JP)

(21) Appl. No.: 19/239,780

(22) Filed: Jun. 16, 2025

(30) Foreign Application Priority Data
Sep. 10, 2024 (JP) 2024-156619

(51) Int. Cl. G06Q 30/0204

(52) U.S. Cl. CPC G06Q 30/0204

(57) ABSTRACT

An information processing apparatus according to the present application includes an estimation unit and a proposal unit, the estimation unit estimates a user group corresponding to a predetermined account in a message application based on usage history of a user in the message application, and the proposal unit proposes information regarding the estimated user group to a business operator who operates the predetermined account.

### CROSS-REFERENCE TO RELATED APPLICATIONS

The present application claims priority to and incorporates by reference the entire contents of Japanese Patent Application No. 2024-156619 filed in Japan on Sep. 10, 2024.

### BACKGROUND OF THE INVENTION

### 1. Field of the Invention

The present invention relates to an information processing apparatus, an information processing method, and a non-transitory computer readable storage medium.

### 2. Description of the Related Art

In the related art, a message service of exchanging messages between a plurality of user terminals through a network has been spread, and a technique of providing a messaging service application (hereinafter, referred to as the message application) for using the message service has been disclosed.

Patent Literature 1: JP 2023-167693 A

However, the technique in the related art aims to improve operability when it is desired to transmit a message to a specific user among many and unspecified users who use a portable terminal or the like, and does not collect interests or behavior information of a user to provide personalized service information such as an advertisement to the user.

### SUMMARY OF THE INVENTION

It is an object of the present invention to at least partially solve the problems in the conventional technology.

An information processing apparatus includes an estimation unit configured to estimate a user group corresponding to a predetermined account in a message application based on usage history of a user in the message application, and a proposal unit configured to propose information regarding the user group estimated by the estimation unit to a business operator who operates the predetermined account.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a diagram illustrating a configuration example of an information processing system according to the embodiment;

FIG. 3 is a diagram illustrating a configuration example of a terminal apparatus according to the embodiment;

FIG. 4 is a diagram illustrating a configuration example of an information processing apparatus according to the embodiment;

FIG. 5 is a diagram illustrating an example of a user information database;

FIG. 6 is a diagram illustrating an example of a user history information database;

FIG. 7 is a diagram illustrating an example of a message service history information database;

FIG. 8 is a diagram illustrating an example of a message service user information database;

FIG. 9 is a diagram illustrating an example of a content that proposes characteristic information of a user segment corresponding to a predetermined score;

FIG. 10 is a flowchart illustrating a procedure according to the embodiment; and

FIG. 11 is a diagram illustrating an example of a hardware configuration.

### DETAILED DESCRIPTION OF THE PREFERRED EMBODIMENTS

Hereinafter, an embodiment for implementing (hereinafter, referred to as “embodiment”) an information processing apparatus, an information processing method, and an information processing program according to the present application will be described in detail with reference to the drawings. The information processing apparatus, the information processing method, and the information processing program according to the present application are not limited to this embodiment. In addition, in the following embodiment, the same components are represented by the same reference numerals, and the repeated description will be omitted.

### 1. Example of Information Processing

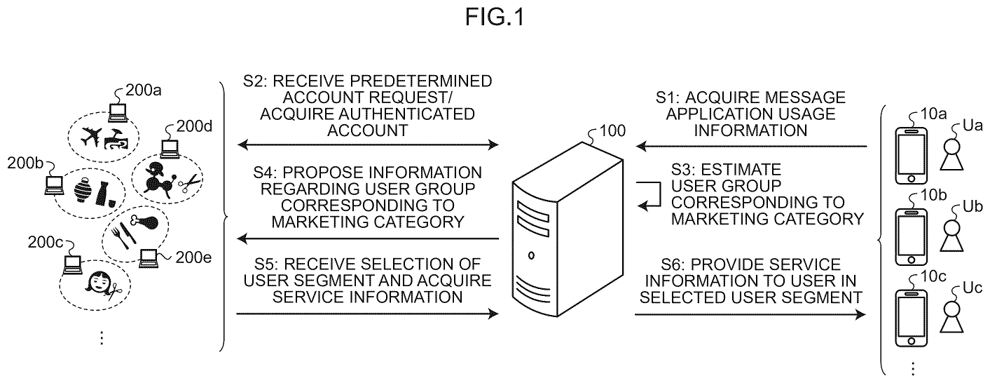

First, an example of information processing according to the embodiment will be described using FIG. 1. FIG. 1 is a diagram illustrating an example of the information processing according to the embodiment, which is executed by an information processing apparatus 100. In FIG. 1, a case where a message application usage information is acquired from a user and information regarding a user group that is a destination of service information is proposed for each of business operators who request for a predetermined account will be described as an example.

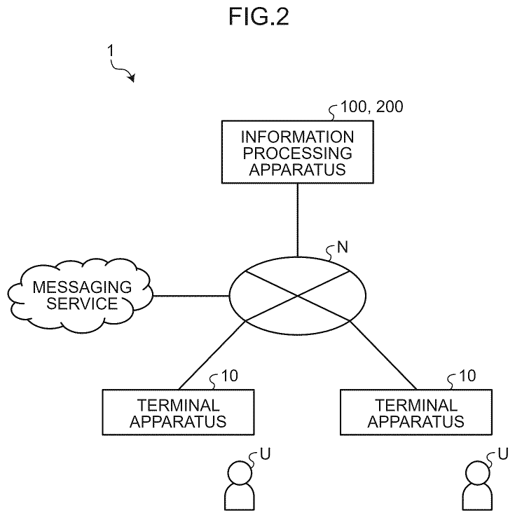

The information processing apparatus 100 illustrated in FIG. 1 is an information processing apparatus that communicably connects terminal apparatuses 10a, 10b, and 10c of a plurality of users Ua, Ub, and Uc to information processing apparatuses 200a to 200e of a predetermined business operator through a network N (refer to FIG. 2) in a wired or wireless manner and provides various information to the users Ua, Ub, and Uc and the predetermined business operator, and is implemented by, for example, one or more servers, cloud systems, or the like. In addition, the information processing apparatuses 200a to 200e are information processing apparatuses that are communicably connected to the terminal apparatuses 10a, 10b, and 10c of the plurality of users Ua, Ub, and Uc through the network N in a wired or wireless manner and provides various information to the terminal apparatuses 10a, 10b, and 10c, and are implemented by, for example, one or more servers, cloud systems, or the like. Hereinafter, the users Ua, Ub, . . . will also be referred to as the user U, and the terminal apparatuses 10a, 10b, . . . will also be referred to as the terminal apparatus 10. In addition, general users will also be referred to as the user U. In addition, the information processing apparatuses 200a, 200b, 200c, . . . will also be referred to as the information processing apparatus 200.

The terminal apparatus 10 is a smart device such as a smartphone or a tablet terminal that is used by the user U, and is a portable terminal apparatus that can communicate with any server apparatus through a wireless communication network such as 4G (Generation) or LTE (Long Term Evolution). In addition, the terminal apparatus 10 includes a screen that is a screen such as a liquid crystal display and has a function of a touch panel, and receives various operations on display data such as a content, for example, receives a tap operation, a slide operation, or a scroll operation from the user U through a finger, a stylus, or the like. An operation that is executed on an area where a content is displayed in the screen may be considered the operation on the content. In addition, the terminal apparatus 10 includes a client application corresponding to a message application in the information processing apparatus 100. The client application of the terminal apparatus 10 according to the embodiment receives an operation from the user and transmits a message including an input character string to the message application of the information processing apparatus 100 through the network N. In addition, the client application of the terminal apparatus 10 notifies the user of the message that is received from the message application of the information processing apparatus 100 through the network N. In addition, the terminal apparatus 10 may be a smart device or may be an information processing apparatus such as a desktop PC (Personal Computer) or a laptop PC.

The information processing apparatus 100 is an information processing apparatus that provides API (Application Programming Interface) services and the like on various applications (hereinafter, applications) and the like and various data to the terminal apparatus 10 of each of the users U in cooperation with the terminal apparatus 10 of each of the users U, and is implemented by a computer, a cloud system, or the like. In addition, the information processing apparatus 100 according to the embodiment includes a message application that communicates with a predetermined messaging service through the network N, for example, to relay messages relating to the predetermined messaging service between the terminal apparatus 10 and the information processing apparatus 200 and between the terminal apparatuses 10 of the plurality of users U.

In addition, the information processing apparatus 100 may be an information processing apparatus that provides any Web service online to the terminal apparatus 10 of each of the users U. For example, the information processing apparatus 100 may provide, as the Web service, a service such as Internet connection, electronic mail service, search service, SNS, electronic commerce (EC), electronic payment, online game, online banking, online trading, hotel and ticket reservation, video and music distribution, news, map, route search, route guidance, line information, traveling information, or weather forecast. Actually, the information processing apparatus 100 may mediate the Web service or may handle the process of the Web service in cooperation with various servers that provide the above-described Web service.

The information processing apparatus 100 can acquire user information regarding the user U. For example, the information processing apparatus 100 acquires information regarding attributes of the user U, for example, a gender, an age, and a place of residence of the user U. The information processing apparatus 100 stores and manages not only identification information (such as a user ID) representing the user U but also information the information regarding the attributes of the user U.

In addition, the information processing apparatus 100 acquires various history information (log data) representing a behavior of the user U from the terminal apparatus 10 of the user U or from various servers or the like based on the user ID or the like. For example, the information processing apparatus 100 acquires position history that is history of a position or date and time of the user U from the terminal apparatus 10. In addition, the information processing apparatus 100 acquires search history that is history of a search query input from the user U from a search server (search engine). In addition, the information processing apparatus 100 acquires browsing history that is history of contents browsed by the user U from a content server. In addition, the information processing apparatus 100 acquires purchase history (payment history) that is history of commodity purchase or payment processing of the user U from an electronic commerce server or a payment processing server. In addition, the information processing apparatus 100 acquires offering information or sales information that is history of offering items on a marketplace of the user U from the electronic commerce server or the payment processing server. The information processing apparatus 100 may acquire posting history of the user U from a posting server or an SNS server that provides a word-of-mouth posting service. The above-described various servers or the like may be the information processing apparatus 100 itself. That is, the information processing apparatus 100 may function as the above-described various servers or the like.

Incidentally, recently, a user executes predetermined registration in a predetermined account, and information transmission of transmitting a message directly from the predetermined account to the user through a message screen is executed. It is known that a message open rate in the message application is higher than an open rate of an e-mail newsletter, the distribution effect is high, and a high marketing effect is expected by distributing information according to preference of the user.

Accordingly, the information processing apparatus 100 according to the embodiment collects interests or behavior information of the user from the usage history of the message application, and provides personalized service information to the user based on the collected information.

### 1-1. Acquisition of Message Application Usage Information

As illustrated in FIG. 1, first, the information processing apparatus 100 acquires the message application usage information regarding the user U (Step S1). When the information processing apparatus 100 relays messages relating to a predetermined messaging service through a message application, the information processing apparatus 100 acquires, for example, a transmission date and time, a reception date and time, a source user ID, a destination user ID, a message, and the like regarding each of the messages received and transmitted by the information processing apparatuses 200 of a plurality of business operators and the terminal apparatuses 10 of a plurality of users U. The information processing apparatus 100 stores the information regarding each of the acquired messages for a predetermined period.

### 1-2. Reception of Predetermined Account Request/Acquisition of Authenticated Account

In addition, the information processing apparatus 100 receives a predetermined account request from the business operator of the information processing apparatus 200, and the business operator of the information processing apparatus 200 acquires, for example, the authenticated account for which a predetermined inspection is cleared (Step S2). The business operator of the information processing apparatus 200 operates the authenticated account and can utilize advantages in attracting customers, for example, message distribution such as notification of a campaign, a chat function, or distribution of a coupon or a shopping cart.

### 1-3. Estimation of User Group Corresponding to Marketing Category

Next, the information processing apparatus 100 estimates a user group having a user attribute that is a marketing target (for example, an assumed customer segment) corresponding to a marketing category relating to a business operator who operates the predetermined account based on the usage history (Step S3). For example, based on message transmission history and message reception history of the plurality of users U, the information processing apparatus 100 estimates the user attribute of the user U having the message transmission history or the message reception history corresponding to the marketing category relating to the business operator who operates the predetermined account, and collects the estimated user attribute as marketing target information. The plurality of users U may be limited to users who execute predetermined registration in an authenticated account of a predetermined business operator. The marketing category is, for example, a product or service segment provided from the business operator who operates the account or a business content category of the business operator who operates the account. In addition, the user attribute is, for example, a user segment or a user persona. The user attribute according to the embodiment is configured with, for example, a keyword relating to the user attribute, and is specifically a user segment or a user persona that is estimated and segmented from the viewpoint of an age, a gender, a residential area, a human relation such as a family structure, an occupation, a hobby, preference, a set of values, a concern, an area having a high usage frequency, a shop, a method of collecting information, or the like. A plurality of predetermined marketing categories may be present, or a plurality of estimated user attributes may be present.

It is considered that the user segment that is estimated based on the message transmission and reception history can be estimated and segmented regarding personality, a lifestyle, a hobby, preference, a set of values, or the like that is a psychological or internal characteristic of the user U corresponding to a psychographic characteristic. Typically, when data corresponding to a psychographic characteristic is collected, for example, a questionnaire survey, an interview, SNS analysis, or the like is executed. In the messaging service, data corresponding to a new psychographic characteristic can be collected at a personal timing based on the message transmission and reception history. For example, discount information or the like that can be used in the service provided from the business operator who operates the predetermined account can be provided to the user U that is segmented into a thrifty user segment based on the estimated and segmented user segment, and high-grade line information or the like in the service provided from the business operator who operates the predetermined account can be easily provided to the user U that is segmented into a high-brand-preferred user segment.

At this time, the information processing apparatus 100 may estimate, by machine learning, the user attribute of the user U that is the marketing target corresponding to the predetermined marketing category from the message transmission history and the message reception history of the plurality of users U. For example, the information processing apparatus 100 generates an estimation model of outputting the user attribute of the user U that is the marketing target corresponding to the predetermined marketing category based on the message transmission history and the message reception history of the user U as input data. A plurality of user attributes may be output. In addition, the plurality of users U may be limited to users who execute predetermined registration in an authenticated account of a predetermined business operator.

Alternatively, in order to estimate the user attribute of the user U that is the marketing target corresponding to the predetermined marketing category from the message transmission history and the message reception history of the plurality of users U, the information processing apparatus 100 may generate, by machine learning, an estimation model of outputting a marketing target score (a marketing target level is possible) based on, as input data, a set including the message transmission history and the message reception history of the user U and the user attribute of the user U that is the marketing target corresponding to the predetermined marketing category. The marketing target score is, for example, a score representing a marketing target level for a message in the message transmission history and the message reception history of the user U that is the marketing target corresponding to the predetermined marketing category. The plurality of users U may be limited to users who execute predetermined registration in an authenticated account of a predetermined business operator.

The information processing apparatus 100 may vectorize each of the message transmission history and the message reception history of the user U and the user attribute of the user U, for example, by image recognition and natural language processing (NLP) to calculate the marketing target score using a cosine similarity of each of the vectors.

The information processing apparatus 100 may generate, by machine learning, an estimation model of outputting the user attribute of the user U based on, as input data, a set including the message transmission history and the message reception history of the plurality of users U and the marketing target score. The information processing apparatus 100 inputs the message transmission history and the message reception history of the plurality of users U and the predetermined marketing target score to the estimation model, and acquires the user attribute of the user U that is the marketing target corresponding to the predetermined marketing category and has a relation with the message transmission history and the message reception history of the user U and the like. The plurality of users U may be limited to users who execute predetermined registration in an authenticated account of a predetermined business operator.

As a method of the machine learning, for example, deep learning, recurrent neural network (RNN), or long short term memory (LSTM) may be used. These methods are exemplary, and the machine learning is not limited to these examples.

In addition, the information processing apparatus 100 may execute the above-described processing only on messages transmitted and received by the plurality of users U for a predetermined period.

In addition, when the user attribute of the user U having the message transmission history or the message reception history corresponding to the predetermined marketing category is estimated, the information processing apparatus 100 may estimate the user attribute of the user U that is the marketing target corresponding to the predetermined marketing category as well as the position history, the purchase history, the search history, and the like of the user U acquired using the identification information (user ID) representing the user U based on profile information or management information associated with a username of the message application. In this case, the estimated user attributes including, for example, a geographic element or a behavior pattern of the user U corresponding to a geographic or behavioral attribute can be estimated and segmented into a plurality of user segments. For example, it is considered, regarding personality, a lifestyle, a hobby, preference, a set of values, or the like that is a psychological or internal characteristic of the user U acquired from the message transmission and reception history, more specifically, the estimated and segmented user segment can be acquired based on information to be searched, a place for meal, a commodity to be purchased, a frequency thereof, and an expense thereof. As a result, the user segment of the user U that is the more specific marketing target can be estimated based on the service provided from the business operator who operates the account and the interests and behavior pattern of the user. For example, when the user U is really close to a predetermined store, a benefit, sales information, or the like can be notified at an appropriate timing from a business operator through a notification message, and the user U can be urged to make a reservation.

In addition, when the user attribute of the user U having the message transmission history or the message reception history corresponding to the predetermined marketing category is estimated, the information processing apparatus 100 may estimate the user attribute of the user U that is the marketing target corresponding to the predetermined marketing category using only the position history, the purchase history, the search history, and the like of the user U acquired using the identification information (user ID) representing the user U based on profile information or management information associated with a username of the message application.

### 1-4. Proposal of Information Regarding User Group Corresponding to Marketing Category

Next, the information processing apparatus 100 proposes information regarding a user group having the estimated user attribute of the user U that is the marketing target corresponding to the predetermined marketing category to the business operator who operates the account (Step S4). The information regarding the user group is characteristic information of the user segment corresponding to the marketing target score for each of the estimated user segments. When the information regarding the user group having the estimated user attribute of the user U that is the marketing target corresponding to the predetermined marketing category is proposed, by inputting, for example, the marketing category and the estimated user segment, the information processing apparatus 100 may generate the characteristic information of the user segment using a generation model of outputting the description of the characteristic of the user segment. The generation model may be, for example, a GPT (generative pretrained transformer) model. Specifically, the information processing apparatus 100 inputs the marketing category and the estimated user segment to the generation model, causes the characteristic information of the user segment corresponding to the marketing target score to be output, and proposes the characteristic information of the user segment corresponding to the output marketing target score to the business operator who operates the account. A plurality of user segments may be proposed.

In addition, the information processing apparatus 100 may propose the characteristic information of the user segment to the business operator who operates the account in the descending order of the marketing target score. In addition, the information processing apparatus 100 may propose the characteristic information of the user segment having a marketing target score of a predetermined threshold or more to the business operator who operates the account.

### 1-5. Reception of Selection of User Segment and Acquisition of Service Information

Next, the information processing apparatus 100 receives selection of the user segment from the business operator who operates the account, and acquires service information for the user segment (Step S5).

### 1-6. Provision of Service Information to User in Selected User Segment

Next, the information processing apparatus 100 provides the service information to the user U in the user segment selected by the business operator who operates the account (Step S6). Specifically, by communicating with a predetermined messaging service through the network N, the information processing apparatus 100 transmits the service information acquired from the business operator who operates the account to the terminal apparatus 10 of the user U in the user segment selected by the business operator.

### 1-7. Regarding Reward

When the information processing apparatus 100 proposes the information regarding the user group having the estimated user attribute of the user U that is the marketing target corresponding to the predetermined marketing category to the business operator who operates the account, the information processing apparatus 100 may ask a predetermined reward for the business operator. In addition, when the business operator who operates the account provides the service information to the user in the user group based on the information regarding the user group having the estimated user attribute of the user U that is the marketing target corresponding to the predetermined marketing category, the information processing apparatus 100 may ask the predetermined reward for the business operator.

This way, the information processing apparatus 100 according to the embodiment collects interests or behavior information of the user based on the usage history of the message application, and provides a message including personalized service information to the user U based on the collected information.

### 2. Configuration Example of Information Processing System

Next, a configuration of an information processing system 1 including the information processing apparatuses 100 and 200 according to the embodiment will be described using FIG. 2. FIG. 2 is a diagram illustrating the configuration example of the information processing system 1 according to the embodiment. As illustrated in FIG. 2, the information processing system 1 according to the embodiment includes the terminal apparatus 10, the information processing apparatuses 100 and 200, and a messaging service. The messaging service is, for example, a messaging service provided from a predetermined message server, a notification server, or the like. These various apparatuses are communicably connected through the network N in a wired or wireless manner. The network N is, for example, a LAN (Local Area Network) or a WAN (Wide Area Network) such as the Internet.

In addition, the number of the apparatuses in the information processing system 1 illustrated in FIG. 2 is not limited to that illustrated in the drawing. For example, FIG. 2 illustrates only two terminal apparatuses 10 to simply the drawing. This configuration is merely exemplary, and the present invention is not limited thereto. However, the number of the terminal apparatuses 10 may be three or more.

The terminal apparatus 10 is an information processing apparatus used by the user U. For example, the terminal apparatus 10 is a smart device such as a smartphone or a tablet terminal, a feature phone, a PC (Personal Computer), a PDA (Personal Digital Assistant), a game machine or AV equipment having a communication function, a car navigation system, a wearable device such as a smartwatch or a head-mounted display, or smart glasses. In addition, the terminal apparatus 10 may be a residence or building, a vehicle, an electric appliance, electronic equipment, or the like that supports IOT (Internet of Things).

In addition, the terminal apparatus 10 is connected to the network N through a wireless communication network such as LTE (Long Term Evolution), 4G (4th Generation), or 5G (5th Generation mobile communication system) or a near field communication wireless communication such as Bluetooth (registered trademark) or a wireless LAN (Local Area Network), and can communicate with the information processing apparatuses 100 and 200.

Each of the information processing apparatuses 100 and 200 is, for example, a computer such as a PC or a blade server or a mainframe or workstation. The information processing apparatuses 100 and 200 may be implemented by cloud computing.

### 3. Configuration Example of Terminal Apparatus

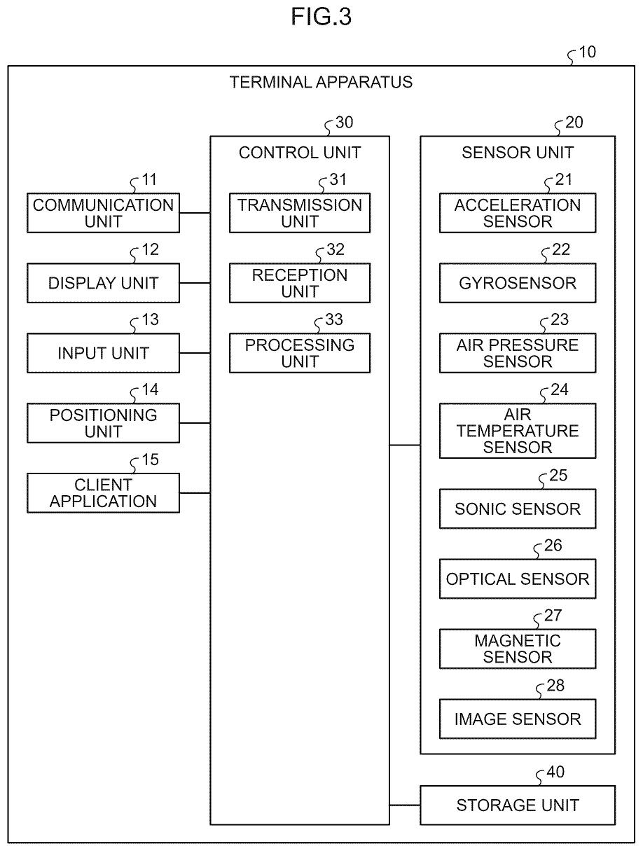

Next, a configuration of the terminal apparatus 10 will be described using FIG. 3. FIG. 3 is a diagram illustrating a configuration example of the terminal apparatus 10. As illustrated in FIG. 3, the terminal apparatus 10 includes a communication unit 11, a display unit 12, an input unit 13, a positioning unit 14, a client application 15, a sensor unit 20, a control unit 30 (controller), and a storage unit 40.

### Communication Unit 11

The communication unit 11 is connected to the network N (refer to FIG. 2) in a wired or wireless manner, and transmits and receives information to and from the information processing apparatus 100 through the network N. For example, the communication unit 11 is implemented by a NIC (Network Interface Card), an antenna, or the like.

### Display Unit 12

The display unit 12 is a display device that displays various information such as positional information. For example, the display unit 12 is a liquid crystal display (LCD) or an organic EL display (Organic Electro-Luminescent Display). In addition, the display unit 12 is a touch panel type display but is not limited thereto.

### Input Unit 13

The input unit 13 is an input device that receives various operations from the user U. For example, the input unit 13 includes buttons for inputting characters, numbers, and the like. the input unit 13 may be an input/output port (I/O port), a USB (Universal Serial Bus) port, or the like. In addition, when the display unit 12 is a touch panel type display, a part of the display unit 12 functions as the input unit 13. In addition, the input unit 13 may be a microphone or the like that receives an audio input from the user U. The microphone may be wireless.

### Positioning Unit 14

The positioning unit 14 receives a signal (radio wave) transmitted from a GPS (Global Positioning System) satellite, and acquires positional information (for example, a latitude and a longitude) representing the current position of the terminal apparatus 10 that is the own apparatus based on the received signal. That is, the positioning unit 14 positions the position of the terminal apparatus 10. The GPS is merely an example of GNSS (Global Navigation Satellite System).

In addition, the positioning unit 14 can measure the position using various methods other than GPS. For example, the positioning unit 14 may measure the position using various communication functions of the terminal apparatus 10 as described below as auxiliary positioning units for position correction or the like.

### Wi-Fi Positioning

For example, the positioning unit 14 measures the position of the terminal apparatus 10 using a Wi-Fi (registered trademark) communication function of the terminal apparatus 10 or using a communication network in each of communication companies. Specifically, the positioning unit 14 measures the position of the terminal apparatus 10 by executing the Wi-Fi communication or the like and measuring the distance to a neighboring base station or access point.

### Beacon Positioning

In addition, the positioning unit 14 may measure the position using a Bluetooth (registered trademark) function of the terminal apparatus 10. For example, the positioning unit 14 measures the position of the terminal apparatus 10 by being connected to a beacon transmitter through the Bluetooth (registered trademark) function.

### Geomagnetic Positioning

In addition, the positioning unit 14 measures the position of the terminal apparatus 10 based on a geomagnetic pattern of a structure that is measured in advance and a geomagnetic sensor in the terminal apparatus 10.

### RFID Positioning

In addition, for example, when the terminal apparatus 10 has a function of the same RFID (Radio Frequency Identification) tag as a contactless IC card of a station ticket gate, a store, or the like or has a function of reading an RFID tag, the terminal apparatus 10 records information regarding execution of payment or the like by the terminal apparatus 10 and a position where the terminal apparatus 10 is used. The positioning unit 14 may measure the position of the terminal apparatus 10 by acquiring the information. in addition, the position may be measured using an optical sensor, an infrared sensor, or the like in the terminal apparatus 10.

The positioning unit 14 may measure the position of the terminal apparatus 10 optionally using one or a combination of the above-described positioning units.

### Client Application 15

The client application 15 transmits a message including a character string input from the user to a message application 140 of the information processing apparatus 100 through a transmission unit 31. In addition, the client application 15 notifies a message received by a reception unit 32 from the message application 140 of the information processing apparatus 100 to the user.

### Sensor Unit 20

The sensor unit 20 includes various sensors mounted on or connected to the terminal apparatus 10. The connection may be wired connection or wireless connection. For example, the sensors may be a detection apparatus other than the terminal apparatus 10, for example, a wearable device or a wireless device. In the example illustrated in FIG. 3, the sensor unit 20 includes an acceleration sensor 21, a gyro sensor 22, an air pressure sensor 23, an air temperature sensor 24, a sonic sensor 25, an optical sensor 26, a magnetic sensor 27, and an image sensor (camera) 28.

Each of the sensors 21 to 28 is merely exemplary and is not limited. That is, the sensor unit 20 may be configured to include some of the sensors 21 to 28, or may include other sensors such as a humidity sensor in addition to or instead of the sensors 21 to 28.

The acceleration sensor 21 is, for example, a three-axis acceleration sensor, and detects physical movements of the terminal apparatus 10 such as a movement direction, a speed, and an acceleration of the terminal apparatus 10. The gyro sensor 22 detects a physical movement of the terminal apparatus 10 such as an inclination of a three-axis direction based on an angular speed of the terminal apparatus 10. The air pressure sensor 23 detects, for example, an ambient pressure of the terminal apparatus 10.

The terminal apparatus 10 includes the acceleration sensor 21, the gyro sensor 22, the air pressure sensor 23, and the like. Therefore, the position of the terminal apparatus 10 can be measured with a technique such as pedestrian dead-reckoning (PDR) using each of these sensors 21 to 23 and the like. As a result, indoor positional information that is difficult to acquire with a positioning system such as GPS can be acquired.

For example, the number of steps, a walking speed, a walking distance can be calculated by a pedometer using the acceleration sensor 21. In addition, a traveling direction, a gaze direction, and a body tilt of the user U can be learned using the gyro sensor 22. In addition, a height or a floor number where the terminal apparatus 10 of the user U is present can also be learned from an air pressure detected by the air pressure sensor 23.

The air temperature sensor 24 detects, for example, an ambient temperature of the terminal apparatus 10. The sonic sensor 25 detects, for example, an ambient sound of the terminal apparatus 10. The optical sensor 26 detects, for example, an ambient illuminance of the terminal apparatus 10. The magnetic sensor 27 detects, for example, an ambient geomagnetism of the terminal apparatus 10. The image sensor 28 acquires, for example, an ambient image of the terminal apparatus 10.

The air pressure sensor 23, the air temperature sensor 24, the sonic sensor 25, the optical sensor 26, and the image sensor 28 can detect an ambient environment or status or the like of the terminal apparatus 10 by detecting the air pressure, the air temperature, the sound, and the illuminance or imaging the ambient image. In addition, the accuracy of the positional information of the terminal apparatus 10 can be improved from the ambient environment or status of the terminal apparatus 10.

### Control Unit 30

The control unit 30 includes, for example, a microcomputer including a CPU (Central Processing Unit), a ROM (Read Only Memory), a RAM, an input/output port, and the like or various circuits. In addition, the control unit 30 may be configured with, for example, hardware of an integrated circuit such as ASIC (Application Specific Integrated Circuit) or FPGA (Field Programmable Gate Array). The control unit 30 includes the transmission unit 31, the reception unit 32, and a processing unit 33.

### Transmission Unit 31

The transmission unit 31 can transmit, for example, various information input from the user U using the input unit 13, various information detected by the sensors 21 to 28 mounted on or connected to the terminal apparatus 10, or the positional information of the terminal apparatus 10 measured by the positioning unit 14 to the information processing apparatus 100 through the communication unit 11.

### Reception Unit 32

The reception unit 32 can receive request of various information provided from the information processing apparatus 100 or various information from the information processing apparatus 100 through the communication unit 11.

### Processing Unit 33

The processing unit 33 includes the display unit 12 and controls the entire terminal apparatus 10. For example, the processing unit 33 can output and display various information transmitted by the transmission unit 31 or various information from the information processing apparatus 100 received by the reception unit 32 to and on the display unit 12.

### Storage Unit 40

The storage unit 40 is implemented by, for example, a semiconductor memory element such as a RAM (Random Access Memory) or a flash memory (Flash Memory) or a storage apparatus such as an HDD (Hard Disk Drive), an SSD (Solid State Drive), or an optical disk. Various programs, various data, or the like are stored in the storage unit 40.

### 4. Configuration Example of Information Processing Apparatus

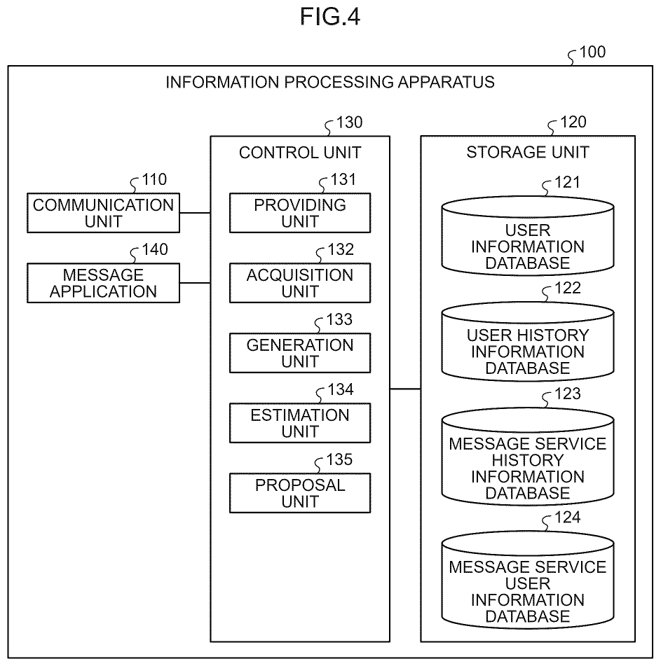

Next, a configuration of the information processing apparatus 100 according to the embodiment will be described using FIG. 4. FIG. 4 is a diagram illustrating a configuration example of the information processing apparatus 100 according to the embodiment. As illustrated in FIG. 4, the information processing apparatus 100 includes a communication unit 110, a storage unit 120, a control unit 130, and the message application 140.

### Communication Unit 110

The communication unit 110 is implemented by, for example, a NIC (Network Interface Card). In addition, the communication unit 110 is connected to the network N (refer to FIG. 2) in a wired or wireless manner.

### Storage Unit 120

The storage unit 120 is implemented by, for example, a semiconductor memory element such as a RAM (Random Access Memory) or a flash memory (Flash Memory) or a storage apparatus such as an HDD, an SSD, or an optical disk. As illustrated in FIG. 4, the storage unit 120 includes a user information database 121, a user history information database 122, a message service history information database 123, and a message service user information database 124.

### User Information Database 121

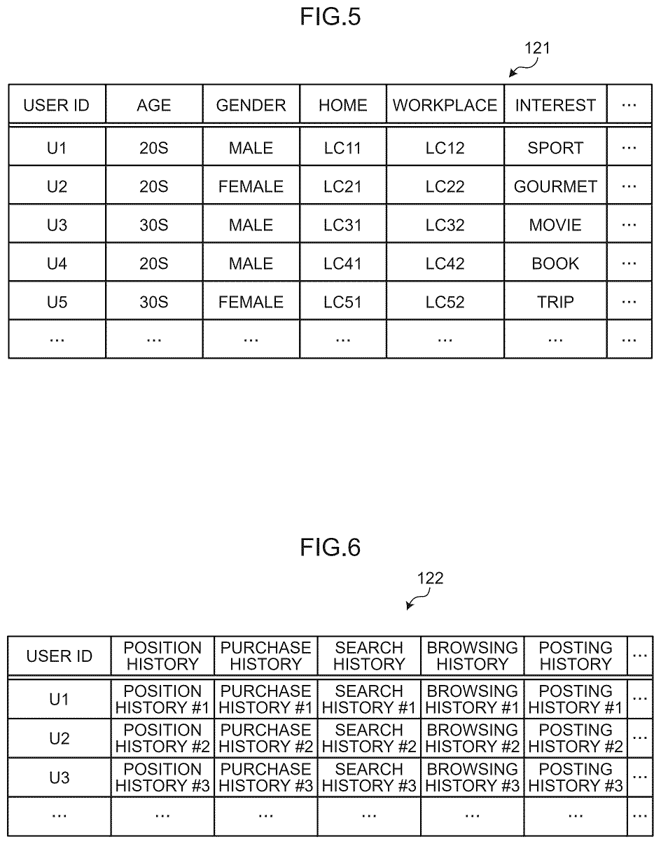

The user information database 121 stores user information regarding the user U. For example, the user information database 121 stores various information such as attributes of the user U. FIG. 5 is a diagram illustrating an example of the user information database 121. In the example illustrated in FIG. 5, the user information database 121 includes items such as “user ID (identifier)”, “age”, “gender”, “home”, “workplace”, and “interest”.

“User ID” represents identification information for identifying the user U. “User ID” may also be contact information (a phone number, an e-mail address, or the like) of the user U, and may also be identification information for identifying the terminal apparatus 10 of the user U.

In addition, “age” represents the age of the user U identified by the user ID. “Age” may be information representing the specific age (for example, 35 years old) of the user U, or may be information representing the age boundary (for example, 30s) of the user U. Alternatively, “age” may be information representing the date of birth of the user U, or may be information representing the generation (for example, born in 80's) of the user U. In addition, “gender” represents the gender of the user U identified by the user ID.

In addition, “home” represents the positional information of the home of the user U identified by the user ID. In the example illustrated in FIG. 5, “home” is represented by an abstract reference numeral such as “LC11”, or may be latitude/longitude information or the like. In addition, for example, “home” may be a regional name or an address.

In addition, “workplace” represents positional information of a workplace (in the case of a student, a school) of the user U identified by the user ID. In the example illustrated in FIG. 5, “workplace” is represented by an abstract reference numeral such as “LC12”, or may be latitude/longitude information or the like. In addition, for example, “workplace” may be a regional name or an address.

In addition, “interest” represents the interest of the user U identified by the user ID. That is, “interest” represents an object of interest of the user U identified by the user ID. For example, “interest” may be a search query (keyword) that is input to a search engine and searched by the user U. In the example illustrated in FIG. 5, for each of the users U, one “interest” is illustrated, but a plurality of “interests” may be illustrated.

For example, in the example illustrated in FIG. 5, the age of the user U identified by the user ID “U1” is “20s”, and the gender is “male”. In addition, for example, regarding the user U identified by the user ID “U1”, the home is “LC11”. In addition, for example, regarding the user U identified by the user ID “U1”, the workplace is “LC12”. In addition, for example, the user U identified by the user ID “U1” is interested in “sport”.

Here, the example illustrated in FIG. 5 is illustrated using abstract values such as “U1”, “LC11”, and “LC12”. “U1”, “LC11”, and “LC12” stores information such as a specific character string or numerical value. Hereinafter, even in the drawings regarding the other information, abstract values may be illustrated.

The user information database 121 is not limited to the above-described example, and may store various information depending on the purpose. For example, the user information database 121 may store various information regarding the terminal apparatus 10 of the user U. In addition, the user information database 121 may store information regarding the attributes of the user U, for example, a demographic attribute, a psychographic attribute, a geographic attribute, and a behavioral attribute. For example, the user information database 121 may store information such as a name, a family structure, a hometown (local area), an occupation, a job position, an income, a qualification, a residence form, presence or absence of a vehicle, a commuting time, a commuting route, a commutation ticket section (a station, a line, or the like), a station having a high usage frequency (other than a station closest to the home or workplace), a lesson (a place, a period of time, or the like), a hobby, an interest, or a lifestyle.

### User History Information Database 122

The user history information database 122 stores various information regarding history information (log data) representing the behavior of the user U. FIG. 6 is a diagram illustrating an example of the user history information database 122. In the example illustrated in FIG. 6, the user history information database 122 has items such as “user ID”, “position history”, “purchase history”, “search history”, “browsing history”, and “posting history”.

“User ID” represents identification information for identifying the user U. In addition, “position history” represents position history that is history of positions or movements of the user U. In addition, “purchase history” represents purchase history that is history of purchases by the user U. In addition, “search history” represents search history that is history of search queries input from the user U. In addition, “browsing history” represents browsing history that is history of contents browsed by the user U. In addition, “posting history” represents posting history that is history of posts by the user U.

For example, in the example illustrated in FIG. 6, the user U identified by the user ID “U1” moves along “position history #1”, purchases a predetermined commodity or the like in a predetermined store or the like according to “purchase history #1”, executes a search according to “search history #1”, browses contents according to “browsing history #1”, and makes posts according to “posting history #1”.

Here, the example illustrated in FIG. 6 is illustrated using abstract values such as “U1”, “position history #1”, “purchase history #1”, “search history #1”, “browsing history #1”, “posting history #1”, and “reaction history #1”. “U1”, “position history #1”, “purchase history #1”, “search history #1”, “browsing history #1”, and “posting history #1” store information such as a specific character string or numerical value.

The user history information database 122 is not limited to the above-described example, and may store various information depending on the purpose. For example, the user history information database 122 may store usage history or the like of a predetermined service of the user U. In addition, the user history information database 122 may store visit history of a physical store or visit history of a facility of the user U. In addition, the user history information database 122 may store payment history or the like in payment (electronic payment) using the terminal apparatus 10 of the user U.

### Message Service History Information Database 123

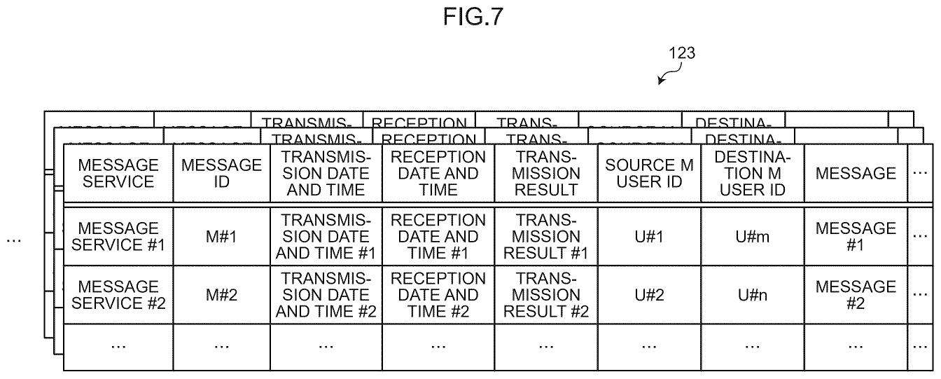

The message service history information database 123 stores various information regarding transmission and reception of messages in the message service. FIG. 7 is a diagram illustrating an example of the message service history information database 123. In the example illustrated in FIG. 7, the message service history information database 123 includes items such as “message service”, “message ID”, “transmission date and time”, “reception date and time”, “transmission result”, “source M user ID”, “destination M user ID”, and “message”.

“Message service” represents the type of the message service. In addition, “message ID” represents identification information for identifying a message. In addition, “transmission date and time” represents the date and time on which a message is transmitted. In addition, “reception date and time” represents the date and time on which a message is received. In addition, “transmission result” represents whether or not transmission is successful. In addition, “source M user ID” represents identification information for identifying a source user who uses the message service. In addition, “destination M user ID” represents identification information for identifying a destination user who uses the message service. “Message” represents a message content.

For example, in the example illustrated in FIG. 7, in a message service “message service #1”, a message “message #1” identified by a message ID “M#1” is transmitted to a source user who uses a message service identified by “U#1” on a transmission date and time “transmission date and time #1”, and is received by a destination user who uses a message service identified by “U#m” on a reception date and time “reception date and time #1”, and the transmission result is “transmission result #1”.

Here, the example illustrated in FIG. 7 is illustrated using abstract values such as “message service #1”, “M#1”, “transmission date and time #1”, “reception date and time #1”, “transmission result #1”, “U#1”, “U#m”, and “message #1”. “Message service #1”, “M#1”, “transmission date and time #1”, “reception date and time #1”, “transmission result #1”, “U#1”, “U#m”, and “message #1” store information such as a specific character string or numerical value.

The message service history information database 123 is not limited to the above-described example, and may store various information depending on the purpose. For example, the message service history information database 123 may store information regarding a message and a message tree.

### Message Service User Information Database 124

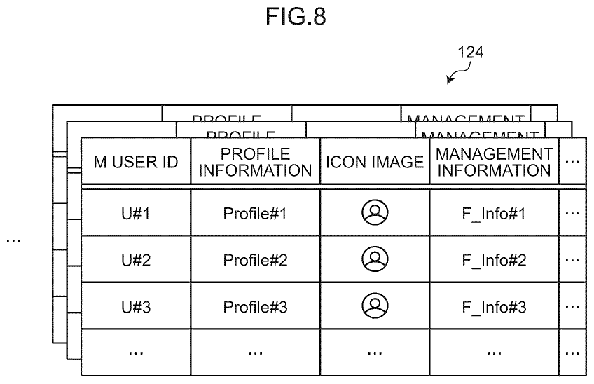

The message service user information database 124 stores various information regarding a user who uses the message service. FIG. 8 is a diagram illustrating an example of the message service user information database 124. In the example illustrated in FIG. 8, the message service user information database 124 includes items such as “M user ID”, “profile information”, “icon image”, and “management information”.

“M user ID” represents identification information for identifying a user who uses the message service. In addition, “profile information” represents profile information of a user who uses the message service. In addition, “icon image” represents an icon image of the user who uses the message service. In addition, “management information” represents management information regarding a user who uses the message service.

For example, in the example illustrated in FIG. 8, the profile information of the user who uses the message service identified by the M user ID “U#1” is “Profile #1”, the icon image is “human icon or the like”, and the management information is “F_Info#1”.

Here, in the example illustrated in FIG. 8, “U#1”, “Profile #1”, “human icon or the like”, and “F_Info#1” store information such as a specific character string, image, or numerical value.

### Control Unit 130

Referring back to FIG. 4, the description is continued. The control unit 130 is a controller and is implemented, for example, when a CPU (Central Processing Unit), an MPU (Micro Processing Unit), an ASIC (Application Specific Integrated Circuit), or a FPGA (Field Programmable Gate Array) executes various programs (corresponding to an example of the information processing program) stored in a storage apparatus inside the information processing apparatus 100 by using a storage area such as a RAM as a work area. In the example illustrated in FIG. 4, the control unit 130 includes a providing unit 131, an acquisition unit 132, a generation unit 133, an estimation unit 134, and a proposal unit 135.

### Providing Unit 131

The providing unit 131 provides the service information to the user U in the user segment selected by the business operator who operates the account.

Specifically, the providing unit 131 provides the service information acquired by the acquisition unit 132 from the business operator who operates the account to the terminal apparatus 10 of the user U in the user segment selected by the business operator through the communication unit 110.

In addition, when the providing unit 131 provides the service information to the user U in the user segment selected by the business operator who operates the account, the providing unit 131 may ask the predetermined reward for the business operator.

### Acquisition Unit 132

The acquisition unit 132 acquires the message application usage information for the user U through the communication unit 110. Specifically, when the acquisition unit 132 relays messages relating to a predetermined messaging service through the message application 140, the acquisition unit 132 acquires, for example, a transmission date and time, a reception date and time, a source user ID, a destination user ID, a message, and the like regarding each of the messages received and transmitted by the information processing apparatuses 200 of a plurality of business operators and the terminal apparatuses 10 of a plurality of users U. The acquisition unit 132 registers information regarding each of the acquired messages in the message service history information database 123 for a predetermined period.

In addition, the acquisition unit 132 receives a predetermined account request from the business operator of the information processing apparatus 200 through the communication unit 110.

In addition, the acquisition unit 132 acquires user information regarding the user U through the communication unit 110. For example, the acquisition unit 132 acquires identification information (user ID or the like) representing the user U, positional information of the user U, attribute information of the user U, and the like from the terminal apparatus 10 of the user U. In addition, the acquisition unit 132 may acquire the identification information representing the user U, the attribute information of the user U, and the like at the time of user registration of the user U. The acquisition unit 132 registers the user information in the user information database 121 of the storage unit 120.

In addition, the acquisition unit 132 acquires various history information (log data) representing a behavior of the user U through the communication unit 110. For example, the acquisition unit 132 may acquire various history information representing the behavior of the user U from the terminal apparatus 10 of the user U or from various servers or the like based on the user ID or the like. The acquisition unit 132 registers various history information in the user history information database 122 of the storage unit 120.

In addition, the acquisition unit 132 acquires a search query input from the user U. For example, when the user U inputs a search query to a search engine or the like and executes a keyword search, the acquisition unit 132 acquires the search query through the communication unit 110. That is, the acquisition unit 132 acquires a keyword input to the search engine or a search window of a side or an application by the user U through the communication unit 110.

In addition, the acquisition unit 132 receives selection of the user segment from the information processing apparatus 200 of the business operator who operates the account through the communication unit 110.

In addition, the acquisition unit 132 acquires service information for the user segment selected by the business operator who operates the account from the information processing apparatus 200 of the business operator through the communication unit 110.

### Generation Unit 133

The generation unit 133 generates an estimation model of outputting the user attribute of the user U that is the marketing target corresponding to the predetermined marketing category based on the message transmission history and the message reception history of the user U as input data. A plurality of user attributes may be output.

In addition, in order to estimate the user attribute of the user U that is the marketing target corresponding to the predetermined marketing category from the message transmission history and the message reception history of the plurality of users U, the generation unit 133 may generate, by machine learning, an estimation model of outputting a marketing target score (a marketing target level is possible) based on, as input data, a set including the message transmission history and the message reception history of the user U and the user attribute of the user U that is the marketing target corresponding to the predetermined marketing category. The marketing target score is, for example, a score representing a marketing target level for a message in the message transmission history and the message reception history of the user U that is the marketing target corresponding to the predetermined marketing category. The plurality of users U may be limited to users who execute predetermined registration in an authenticated account of a predetermined business operator.

In addition, the generation unit 133 may generate, by machine learning, an estimation model of outputting the user attribute of the user U based on, as input data, a set including the message transmission history and the message reception history of the plurality of users U and the marketing target score. The generation unit 133 inputs the message transmission history and the message reception history of the plurality of users U and the predetermined marketing target score to the estimation model, and acquires the user attribute of the user U that is the marketing target corresponding to the predetermined marketing category and has a relation with the message transmission history and the message reception history of the user U and the like. The plurality of users U may be limited to users who execute predetermined registration in an authenticated account of a predetermined business operator.

In addition, by inputting, for example, the marketing category and the estimated user segment, the generation unit 133 may generate the characteristic information using a generation model of outputting the description of the characteristic of the user segment. The generation model may be, for example, a GPT (generative pretrained transformer) model.

### Estimation Unit 134

The estimation unit 134 estimates a user group (persona) having a user attribute that is a marketing target (for example, an assumed customer segment) corresponding to a marketing category relating to a business operator who operates the predetermined account based on the usage history. For example, based on message transmission history and message reception history of the plurality of users U, the estimation unit 134 estimates the user attribute of the user U having the message transmission history or the message reception history corresponding to the marketing category relating to the business operator who operates the predetermined account, and collects the estimated user attribute as marketing target information. The plurality of users U may be limited to users who execute predetermined registration in an authenticated account of a predetermined business operator. The marketing category is, for example, a product or service segment provided from the business operator who operates the account or a business content category of the business operator who operates the account. In addition, the user attribute is, for example, a user segment or a user persona. The user attribute according to the embodiment is configured with, for example, a keyword relating to the user attribute, and is specifically a user segment or a user persona that is estimated and segmented from the viewpoint of an age, a gender, a residential area, a human relation such as a family structure, an occupation, a hobby, preference, a set of values, a concern, an area having a high usage frequency, a shop, a method of collecting information, or the like. A plurality of predetermined marketing categories may be present, or a plurality of estimated user attributes may be present.

In this case, the estimation unit 134 may estimate, by machine learning, the user attribute of the user U that is the marketing target corresponding to the predetermined marketing category from the message transmission history and the message reception history of the plurality of users U. For example, the estimation unit 134 generates an estimation model of outputting the user attribute of the user U that is the marketing target corresponding to the predetermined marketing category based on the message transmission history and the message reception history of the user U as input data. A plurality of user attributes may be output. In addition, the plurality of users U may be limited to users who execute predetermined registration in an authenticated account of a predetermined business operator.

In addition, when the user attribute of the user U having the message transmission history or the message reception history corresponding to the predetermined marketing category is estimated, the estimation unit 134 may estimate the user attribute of the user U that is the marketing target corresponding to the predetermined marketing category also in consideration of the position history, the purchase history, the search history, and the like of the user U acquired using the identification information (user ID) representing the user U based on profile information or management information associated with a username of the message application.

In addition, when the user attribute of the user U having the message transmission history or the message reception history corresponding to the predetermined marketing category is estimated, the estimation unit 134 may estimate the user attribute of the user U that is the marketing target corresponding to the predetermined marketing category using only the position history, the purchase history, the search history, and the like of the user U acquired using the identification information (user ID) representing the user U based on profile information or management information associated with a username of the message application.

### Proposal Unit 135

The proposal unit 135 proposes information regarding a user group having the estimated user attribute of the user U that is the marketing target corresponding to the predetermined marketing category to the business operator who operates the account.

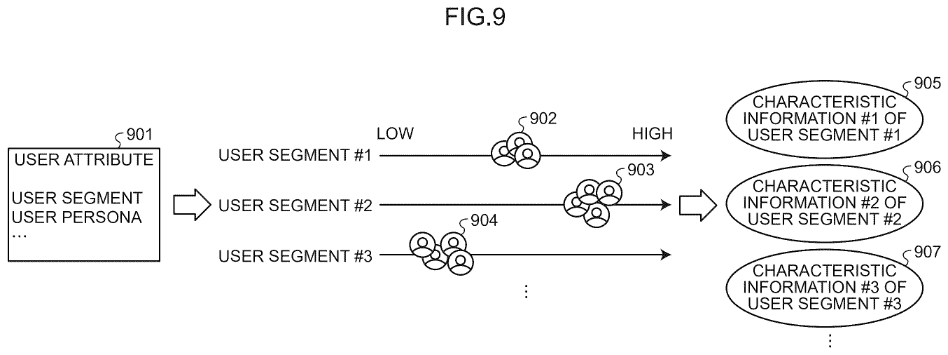

In addition, the proposal unit 135 inputs the marketing category and the estimated user segment to the generation model, causes the characteristic information of the user segment corresponding to the marketing target score to be output, and proposes the characteristic information of the user segment corresponding to the output marketing target score to the business operator who operates the account. A plurality of user segments may be proposed. FIG. 9 is a diagram illustrating an example of a content of proposing the characteristic information of the user segment corresponding to the marketing target score to the business operator who operates the account. In the example illustrated in FIG. 9, among estimated user attributes 901, each of user segment #1, user segment #2, and user segment #3 are user segments estimated as marketing target scores (marketing target levels) 902, 903, and 904, respectively, and by inputting the marketing category and the estimated user segment, characteristic information generated using the generation model of outputting the description of the characteristic of user segment corresponding to the marketing target scores are “characteristic information #1 of user segment #1” 905, “characteristic information #2 of user segment #2” 906, and “characteristic information #3 of user segment #3” 907.

In addition, the proposal unit 135 may propose the characteristic information of the user segment to the business operator who operates the account in the descending order of the marketing target score. In addition, the proposal unit 135 may propose the characteristic information of the user segment having a marketing target score of a predetermined threshold or more to the business operator who operates the account.

In addition, when the proposal unit 135 proposes the information regarding the user group having the estimated user attribute of the user U that is the marketing target corresponding to the predetermined marketing category to the business operator who operates the account, the information processing apparatus 100 may ask a predetermined reward for the business operator.

### Message Application 140

The message application 140 communicates with a predetermined messaging service through the communication unit 110 and, for example, relays messages between the terminal apparatus 10 and the information processing apparatus 200 and between the terminal apparatuses 10 of the plurality of users U.

### 5. Procedure

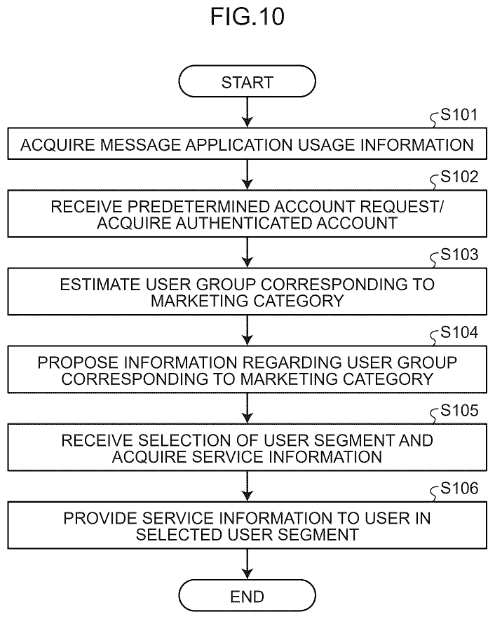

Next, a procedure of the information processing apparatus 100 according to the embodiment will be described using FIG. 10. FIG. 10 is a flowchart illustrating the procedure according to the embodiment. The procedure described below is repeatedly executed by the control unit 130 of the information processing apparatus 100.

As illustrated in FIG. 10, the acquisition unit 132 of the information processing apparatus 100 acquires the message application usage information through the communication unit 110 (Step S101).

Next, the acquisition unit 132 of the information processing apparatus 100 receives a predetermined account request through the communication unit 110, and the acquisition unit of the information processing apparatus 200 acquires the authenticated account (Step S102).

Next, the estimation unit 134 of the information processing apparatus 100 estimates a user group corresponding to the marketing category (Step S103).

Next, the proposal unit 135 of the information processing apparatus 100 proposes information regarding the user group corresponding to the marketing category (Step S104).

Next, the acquisition unit 132 of the information processing apparatus 100 receives selection of the user segment through the communication unit 110 and acquires the service information (Step S105).

Next, the providing unit 131 of the information processing apparatus 100 provides the service information to the user in the selected user segment through the communication unit 110 (Step S106).

### 6. Modification Example

The terminal apparatus 10 and the information processing apparatus 100 described above may be implemented in various different forms other than the above-described embodiment. Accordingly, modification examples of the embodiment will be described below.

In the above-described embodiment, some of the processes that are executed by the information processing apparatus 100 may be actually executed by the terminal apparatus 10. For example, the process may be completed by a stand-alone apparatus (by the terminal apparatus 10 alone). In this case, the terminal apparatus 10 may have a function of the information processing apparatus 100 according to the above-described embodiment. In addition, in the above-described embodiment, the terminal apparatus 10 cooperates with the information processing apparatus 100. Therefore, when seen from the user U, the process of the information processing apparatus 100 looks to be executed by the terminal apparatus 10. That is, from another viewpoint, it can be said that the terminal apparatus 10 includes the information processing apparatus 100.

For example, the terminal apparatus 10 may execute the process of the information processing apparatus 100 according to the above-described embodiment as a process of an installed application. That is, the process of the information processing apparatus 100 according to the above-described embodiment may be a process of an application installed in the terminal apparatus 10.

### 7. Effect

As described above, an information processing apparatus (the terminal apparatus 10 and the information processing apparatus 100) according to the present application includes: an estimation unit 134 configured to estimate a user group corresponding to a predetermined account in a message application based on usage history of a user in the message application; and a proposal unit 135 configured to propose information regarding the estimated user group to a business operator who operates the predetermined account.

The information processing apparatus according to the present application further includes an acquisition unit 132 configured to acquire a request for a predetermined account in the message application.

The estimation unit 134 estimates a user group having a user attribute that is a marketing target corresponding to a marketing category relating to the business operator who operates the predetermined account based on the usage history.

The proposal unit 135 proposes information regarding the user group estimated by the estimation unit 134 to the business operator who operates the predetermined account.

The acquisition unit 132 acquires service information for a user segment from the business operator who operates the predetermined account, the user segment being selected from the user group by the business operator who operates the predetermined account.

The information processing apparatus according to the present application further includes a providing unit 131 configured to provide the service information to a user in the user segment.

With any one or a combination of the above-described processes, the information processing apparatus according to the present application can provide personalized service information to a user based on usage history of a message application.

### 8. Hardware Configuration

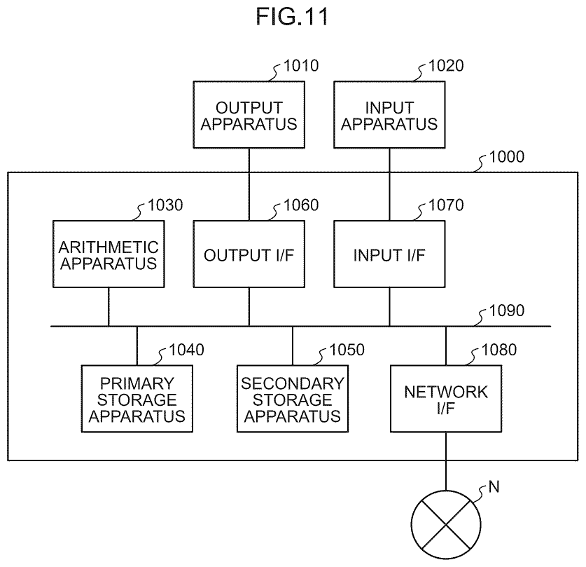

In addition, the terminal apparatus 10 or the information processing apparatus 100 according to the above-described embodiment is implemented by, for example, a computer 1000 having a configuration illustrated in FIG. 11. Hereinafter, the information processing apparatus 100 will be described as an example. FIG. 11 is a diagram illustrating an example of a hardware configuration. The computer 1000 is connected to an output apparatus 1010 and an input apparatus 1020, and has a form in which an arithmetic apparatus 1030, a primary storage apparatus 1040, a secondary storage apparatus 1050, an output I/F (Interface) 1060, an input I/F 1070, and a network I/F 1080 are connected through a bus 1090.

The arithmetic apparatus 1030 operates based on a program stored in the primary storage apparatus 1040 or the secondary storage apparatus 1050 or a program read from the input apparatus 1020, or the like to execute various processes. The arithmetic apparatus 1030 is implemented by, for example, a CPU (Central Processing Unit), an MPU (Micro Processing Unit), an ASIC (Application Specific Integrated Circuit), or an FPGA (Field Programmable Gate Array).

The primary storage apparatus 1040 is a memory apparatus, such as a RAM (Random Access Memory), that primarily stores data used for various arithmetic operations by the arithmetic apparatus 1030. In addition, the secondary storage apparatus 1050 is a storage apparatus where data or various databases used for various arithmetic operations by the arithmetic apparatus 1030 are registered, and is implemented by a ROM (Read Only Memory), an HDD (Hard Disk Drive), an SSD (Solid State Drive), a flash memory, or the like. The secondary storage apparatus 1050 may be an internal storage or an external storage. In addition, the secondary storage apparatus 1050 may be a removable storage medium such as a USB (Universal Serial Bus) memory or an SD (Secure Digital) memory card. In addition, the secondary storage apparatus 1050 may be a cloud storage (online storage), a NAS (Network Attached Storage), a file server, or the like.

The output I/F 1060 is an interface for transmitting information that is an output target to the output apparatus 1010 such as a display, a projector, or a printer that outputs various information. For example, the output I/F 1060 is implemented by a connector of a standard such as USB (Universal Serial Bus), DVI (Digital Visual Interface), or HDMI (registered trademark) (High Definition Multimedia Interface). In addition, the input I/F 1070 is an interface for receiving information from various input apparatuses 1020 such as a mouse, a keyboard, a keypad, a button, and a scanner, and is implemented by, for example, a USB.

In addition, the output I/F 1060 and the input I/F 1070 may be wirelessly connected to the output apparatus 1010 and the input apparatus 1020, respectively. That is, the output apparatus 1010 and the input apparatus 1020 may be wireless equipment.

In addition, the output apparatus 1010 and the input apparatus 1020 may be integrated equipment such as a touch panel. In this case, the output I/F 1060 and the input I/F 1070 may be integrated as an input/output I/F.

The input apparatus 1020 may be, for example, an apparatus that reads information from an optical recording medium such as CD (Compact Disc), DVD (Digital Versatile Disc), or PD (Phase change rewritable Disk), a magneto-optical recording medium such as MO (Magneto-Optical disk), a tape medium, a magnetic recording medium, a semiconductor memory, or the like.

The network I/F 1080 receives data from another equipment through the network N, transmits the received data to the arithmetic apparatus 1030, and transmits data generated by the arithmetic apparatus 1030 to another equipment through the network N.

The arithmetic apparatus 1030 controls the output apparatus 1010 or the input apparatus 1020 through the output I/F 1060 or the input I/F 1070. For example, the arithmetic apparatus 1030 loads a program from the input apparatus 1020 or the secondary storage apparatus 1050 to the primary storage apparatus 1040, and executes the loaded program.

For example, when the computer 1000 functions as the information processing apparatus 100, the arithmetic apparatus 1030 of the computer 1000 implements the function of the control unit 130 by executing the program loaded to the primary storage apparatus 1040. In addition, the arithmetic apparatus 1030 of the computer 1000 may load a program acquired from another equipment through the network I/F 1080 to the primary storage apparatus 1040 to execute the loaded program. In addition, the arithmetic apparatus 1030 of the computer 1000 may read a function of a program, data, or the like from another program of another equipment to use the read function, data, or the like in cooperation with the other equipment through the network I/F 1080.

### 9. Others

Hereinabove, the embodiments of the present application have been described, but the present invention is not limited to the contents of these embodiments. In addition, the above-described components can be easily conceived by those skilled in the art, and include substantially the same components, that is, components in a so-called equivalent range. Further, the above-described components can be appropriately combined. Further, various omissions, substitutions, or changes can be made for the components within a range not departing from the scope of the above-described embodiments.

In addition, among the processes described in the above-described embodiments, all or some of the processes that are assumed to be automatically executed in the description can also be manually executed, or all or some of the processes that are assumed to be manually executed in the description can also be automatically executed using a well-known method. In addition, the information including the procedure, the specific names, and various data or parameters described in the above documents or illustrated in the drawings can be freely changed unless otherwise specified. For example, various information illustrated in each of the drawings are not limited the illustrated information.

In addition, each of the components of each of the apparatuses is functionally conceptual, and does not need to be physically configured as illustrated in the drawings. That is, the specific form of distribution and integration of the apparatuses is not limited to that illustrated in the drawings, and all of some of the apparatuses may be configured to be functionally or physically distributed or integrated in any units according to various loads, usages, and the like.

For example, the above-described information processing apparatus 100 may also be implemented by a plurality of server computers, and the configuration can be flexibly changed depending on functions, for example, can be implemented by reading an external platform or the like through an API (Application Programming Interface), network computing, or the like.

In addition, the embodiments and the modification examples described above can be appropriately combined within a range where the processing contents are not contradictory to each other.

In addition, “section, module, or unit” described above can be replaced with “unit”, “circuit”, or the like. For example, the acquisition unit can be replaced with an acquisition unit or an acquisition circuit.

According to the present invention, personalized service information can be provided to a user based on usage history of a message application.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
an estimation unit configured to estimate a user group corresponding to a predetermined account in a message application based on usage history of a user in the message application; and
a proposal unit configured to propose information regarding the user group estimated by the estimation unit to a business operator who operates the predetermined account.

2. The information processing apparatus according to claim 1, further comprising an acquisition unit configured to acquire a request for a predetermined account in the message application.

3. The information processing apparatus according to claim 2, wherein the estimation unit estimates a user group having a user attribute that is a marketing target corresponding to a marketing category relating to the business operator who operates the predetermined account based on the usage history.

4. The information processing apparatus according to claim 3, wherein the proposal unit proposes information regarding the user group estimated by the estimation unit to the business operator who operates the predetermined account.

5. The information processing apparatus according to claim 4, wherein the acquisition unit acquires service information for a user segment from the business operator who operates the predetermined account, the user segment being selected from the user group by the business operator who operates the predetermined account.

6. The information processing apparatus according to claim 5, further comprising a providing unit configured to provide the service information to a user in the user segment.

7. An information processing method that is executed by an information processing apparatus, the method comprising:
estimating that estimates a user group corresponding to a predetermined account in a message application based on usage history of a user in the message application; and
proposing that proposes information regarding the user group estimated in the estimation step to a business operator who operates the predetermined account.

8. A non-transitory computer readable storage medium having stored therein an information processing program that causes a computer to execute:
estimating that estimates a user group corresponding to a predetermined account in a message application based on usage history of a user in the message application; and
proposing that proposes information regarding the user group estimated in the estimation procedure to a business operator who operates the predetermined account.
